(19) United States
(12) Patent Application Publication
(10) Pub. No.: US 2026/0212325 A1
(43) Pub. Date: Jul. 23, 2026

(54) Asynchronous Distributed Task Allocation Platform.

(71) Applicants: Roie ZIVAN, Meitar (IL); Sofie Amador Nelke, Kiryat Ono (IL); Ben Rachmut, Beer Sheva (IL)

(72) Inventors: Roie ZIVAN, Meitar (IL); Sofie Amador Nelke, Kiryat Ono (IL); Ben Rachmut, Beer Sheva (IL)

(21) Appl. No.: 19/144,951

(22) PCT Filed: Jan. 11, 2024
(86) PCT No.: PCT/IB2024/050302

§ 371 Date: Jun. 30, 2025

Related U.S. Application Data
(60) Provisional application No. 63/436,892, filed on Jan. 4, 2023.

(51) Int. Cl. G06Q 10/109; G06Q 10/0631

(52) U.S. Cl. CPC G06Q 10/1097; G06Q 10/063112

(57) ABSTRACT

A method, device and a computerized device for asynchronously scheduling tasks even when facing communication errors. Multi-agent task allocation in physical environments with spatial and temporal constraints, are hard problems that are relevant in many realistic applications. There is a growing need to provide a robust solution for task allocation. There is provided an asynchronous and distributed task allocation process based on Fisher market clearing (referred to as the “suggested process”), that is robust to message latency and message loss.

### CROSS REFERENCE

This application claims priority from U.S. provisional patent Ser. No. 63/436,892 filing date Jan. 4, 2023 which is incorporated herein in its entirety.

### BACKGROUND

Task allocation is a major challenge in realistic scenarios, e.g., disaster response, where medical personnel, fire fighters, police, and mechanical entities (e.g., drones and unmanned ground vehicles) need to coordinate their actions in order to save as many victims as possible. Such coordination is extremely challenging since in such scenarios the communication among agents is expected to be severely degraded and unreliable.

The quality of communication may be severely degraded and unreliable in the disaster areas due to damages to cell transmission towers and high demand that can cause an overload of the cell phone network

Moreover, such scenarios are highly dynamic due to the appearance of new events or the change of the status of handled events.

There is a growing need to provide a robust solution for task allocation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of an environment;

FIG. 2 illustrates an example of a computerized device;

FIG. 3 illustrates an example of a method;

FIG. 4 illustrates an example of a method;

FIG. 5 illustrates an example of a method; and

FIG. 6 illustrates an example of a method.

### DETAILED DESCRIPTION OF THE DRAWINGS

Multi-agent task allocation in physical environments with spatial and temporal constraints, are hard problems that are relevant in many realistic applications.

US patent application 2021/0133663 of Ziavn et al. titled “Market equilibrium mechanism for task allocation” illustrates a synchronous and centrally controlled multi-agent task allocation process. The synchronous and centrally controlled multi-agent task allocation process depends on perfect communication between agents. The synchronous and centrally controlled multi-agent task allocation process required that in each iteration of the process, agents perform calculations only after they received all messages that they expect to be sent to them by their neighbors. Unfortunately, such a synchronous algorithmic design incurs a number of drawbacks. Each synchronous operation is performed only after all messages sent in the previous iteration arrives, i.e., if a message is delayed, the iteration starts late. If a message is lost, the agents are in a deadlock. Moreover, the algorithm was dependent on perfect knowledge that the agents hold regarding the existence and importance of tasks to be performed. Thus, the team of agents was not independent and relied on a centralized system that would update them with the tasks that needed to be performed.

There is provided an asynchronous and distributed task allocation process based on Fisher market clearing (referred to as the “suggested process”), that is robust to message latency and message loss. It has been shown that the suggested process properly operated—for example provided consistent results regardless the loss of at least 10, 20, 30, 40, 50, 60, 70, 80 and even 90 percent of the messages sent during the execution of the suggested process.

According to an embodiment, assuming that there are agents of computerized devices that are (at absence of communication problems) within reach of each other (can communicate with each other), then the asynchronous nature of the scheduling process includes executing a scheduling iteration without knowledge of the status of the entire agents—and/or without waiting for the response from all agents. A scheduling iteration is responsive to partial information—such as one or more messages from one or more skill agents—while the one or more messages do not amount to messages from all of the agents. While some of the examples listed below refer to an execution of a scheduling iteration per a single message—the scheduling iteration may be executed per a number of messages—the number of messages is lower than the number of the messages if sent from all agents.

The suggested process may operate even when the number and/or identity of the skill agents changes from one iteration to another.

The suggested process allows agents to identify dynamic events and initiate the generation of an updated allocation. Thus, it is more compatible for dynamic environments.

The suggested process allows skill agents to perform computation and generate messages whenever they receive a message from a task agent.

According to an embodiment, the suggested process performs a single phase in which the allocation of tasks to skill agents, the ad-hoc coalitions (of a task agent and skill agents) that share a task and the schedule for each skill agent are produced. Such a single-phase suggested process results in its ability to report an allocation at any given time throughout its execution.

According to an embodiment, the suggested process allows agents to detect dynamic events such as events that trigger an execution of new tasks that need to be performed or a change in the importance of a task that is currently being handled, and trigger execution of the scheduling process, for related agents to adapt to the evolved problem.

It has been shown that the suggested process is adapted to operate in in realistic military and disaster response scenarios—and that the communication conditions in such scenarios (or any scenarios in which there are communication problems) justify a distributed implementation of the algorithm instead of a centralized, in which a central system is updated by the agents on the dynamic events that occur, calculates and updated allocation and schedule; and informs the agents.

It has been found that in case of message latency, there is a clear threshold from which the suggested solution is motivated, and that when message loss is possible, the suggested process is preferred.

In contrary to a synchronous solution—a task agent is not stuck when it does not receives messages from all agents (or from all agents relevant to the task).

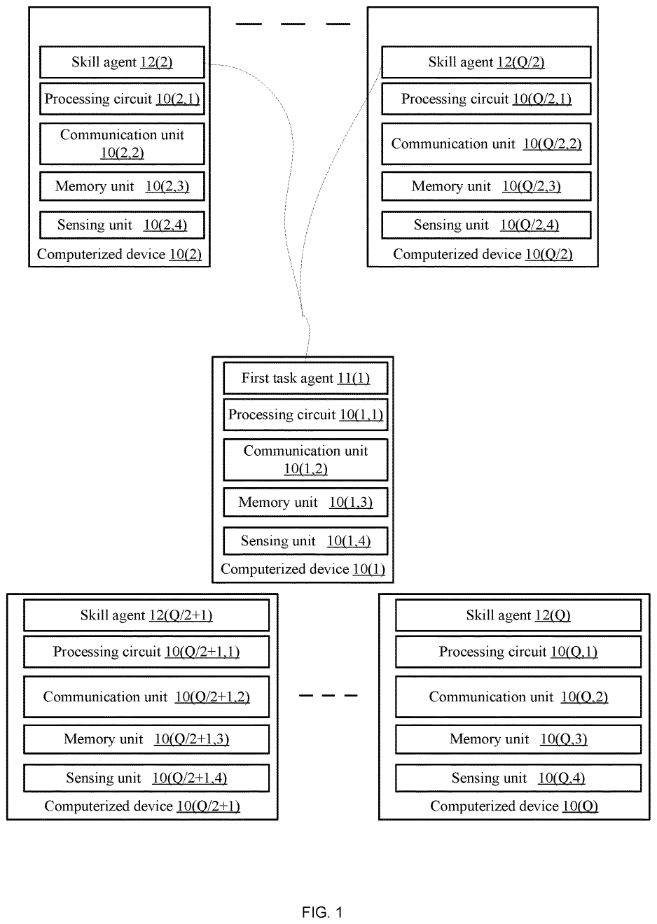

FIG. 1 illustrates an example of computerized devices 10(1)-10(Q), wherein Q is an integer that exceeds (or be equal to) 2, 3, 4, 5, 10, 20, 50, 100, 120, 150, 180, 200, 220, 280, 300, 400, 500 and the like.

Each computerized devices include a processing circuit, a communication unit, a memory unit and may also include a sensing unit.

See for example:
first computerized device 10(1) that includes processing circuit 10(1,1), communication unit 10(1,2), memory unit 10(1,3), and may also include a sensing unit 10(1,4).
(Q/2)'th computerized device 10(Q/2) that includes processing circuit 10(Q/2,1), communication unit 10(Q,2), memory unit 10(Q,3), and may also include a sensing unit 10(Q/2,4).
(Q/2+1)'th computerized device 10(Q/2+1) that includes processing circuit 10(Q/2+1,1), communication unit 10(Q,2), memory unit 10(Q,3), and may also include a sensing unit 10(Q/2+1,4).
Q'th computerized device 10(Q) that includes processing circuit 10(Q,1), communication unit 10(Q,2), memory unit 10(Q,3), and may also include a sensing unit 10(Q,4).

It is assumed that a computerized device 10(1) hosts a first task agent (11(1)) that manages a scheduling process related to a first task, and that computerized devices 10(2)-10(Q/2) host skill agents 12(2)-12(Q/2) that are relevant to the execution of the first task. The suggested process is operable even when communication is disrupted between the task agents and one or more skill agents.

It should be noted that multiple tasks can be concurrently scheduled by various agents. According to an embodiment, a hosting of an agent (task agent and/or skill agent) includes having a processing circuit that is configured to execute instructions and/or code and/or software and/or firmware for performing the role of (for acting as) the agent.

According to an embodiment the same computerized device is configured to host multiple agents—the hosted agents may be only task agents, only skill agents or a combination of one or more task agent and one or more skill agent.

A task agent hosted by a given computerized system may be configured to schedule an execution of a task that involves multiple skill tasks—whereas the multiple skill tasks are hosted by hosted by one or more other computerized systems. Alternatively—at least one of the multiple skill tasks is hosted by the given computerized system.

According to an embodiment—the computerized system include one or more processing circuits. A processing circuit that schedules the execution of a task is referred to as a task processing circuit. A processing circuit that executes one or more sub-tasks of a task is referred to as a skill processing circuit.

The task processing circuit may differ from the skill processing circuit. Alternatively, a task processing circuit may be the skill processing circuit.

According to an embodiment, the same processing circuit is configured to schedule an execution of one or more tasks while concurrently executing one or more sub-tasks.

A computerized device may belong of associated with any type of vehicle or any static system.

The computerized device may be a part of (or associated with) at least one of the following:
A static or movable detection system that covers one or more targets in one or more area.
Rescue and/or medical systems of rescue and/or medical teams.
An autonomous vehicle—such as but not limited to agriculture autonomous vehicles (tractors, drones etc. . . . ).
Military equipment—such as airborne military equipment, submerged military equipment or ground military equipment (for example Automated Guided Vehicles and Unmanned Ground Vehicles).
According to an embodiment the skill agents communicate with task agents but to not communicate with other skill agents.

According to an embodiment, a task agent dynamically updates the skill agents and the allocation of skill agents over time—and may, for example define a time window (of a duration of, for example, 1-5 minutes—or any other duration)—in which a skill agent that did not respond to any message is removed (at least temporarily) from the skill agents—and has it's allocated workload is assigned to another skill agent(s). Alternatively—the skill agents is not removed.

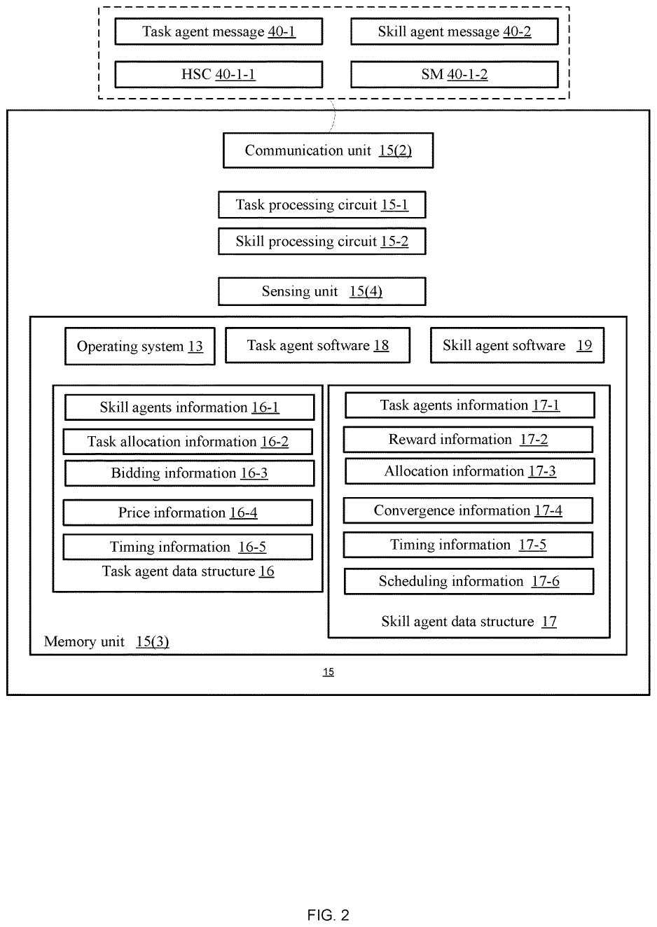

FIG. 2 illustrates an example of computerized device 15.

Computerized device 15 includes a task processing circuit 15-1, a skill processing circuit 15-2.

According to an embodiment, computerized device also includes memory unit 15(3), communication unit 15(2), and sensing unit 15(4).

The communication circuit may be operative to communicate between different units and/or circuits of the computerized device and/or to exchange messages with other computerized devices—such as a skill agent message 40-2 and task agent message 40-1 (such as handshake message HCS 40-1-1 and SM 40-1-2).

According to an embodiment, the task processing circuit 15-1 is configured to: (a) determine to operate as a task agent of the task; (b) determine skills that are required for an execution of sub-tasks of the task; (c) detect skill agents that have a skill of the skills, based on an analysis of messages received from the skill agents; and (d) execute a scheduling process that is asynchronous and comprises multiple iterations.

According to an embodiment, an execution by the task processing circuit of each iteration of the multiple iteration includes:
(d.1) asynchronously receiving, by the task processing circuit, a skill agent message from any of the skill agents. The skill agent message includes (i) a bidding value related to a cost of using a skill of the skill agent during an execution of a sub-task, and (ii) timing information indicative of a suggested timing execution of the sub-task by the skill agent.
(d.2) updating, by the task processing circuit and based on a content of the skill agent message, a task agent data structure that is indicative of a state of the scheduling process, the task agent data structure is stored in the memory unit. According to an embodiment the updating requires to change a low number of values while applying simple and defined operations.
(d.3) analyzing the scheduling data structure, by the task processing circuit, to determine whether the scheduling process has converged. According to an embodiment the scheduling is executed in real time—for example each iteration may be completed within a fraction of a second, a few seconds and the like.
(d.4) following a determining that the scheduling process converged—(d.6) determining by the task processing circuit, a schedule of executing the task, and (d.7) triggering by the task processing circuit, a transmission of scheduling instructions to the skill agents, by the task processing circuit and.
(d.5) following a determining that the scheduling process is not converged, (d.8) triggering by the task processing circuit a transmission of a task agent message to the relevant skill agents, the task agent message is indicative of an updated status of the scheduling process.
Step (d.8) is followed by an execution of another iteration of the scheduling process.

According to an embodiment, the processing circuit is implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The memory unit is configured to store an operating system 13, task agent software 18, skill agent software 19, task agent data structure 16 and skill agent data structure 17.

According to an embodiment, the task agent data structure 16 stores (a) skill agents information 16-1 indicative of the detected skill agents, (b) task allocation information 16-2 indicative of an allocation of sub-tasks of the task to the skill agents, (c) bidding information 16-3 indicative of bids from the skill agents related to execution of the sub-tasks of the tasks, (d) price information 16-4 indicative of sums of prices per sub-task of the task, and (e) timing information 16-5 regarding a suggested timing for starting at least one sub-task of the task.

According to an embodiment, each information item listed above (16-1 till 16-5) is stored in a different file of the scheduling data structure. According an embodiment, one or more items are stored in a single file of the scheduling data structure. According to an embodiment, an item is stored in more thana single file of the scheduling data structure.

According to an embodiment, at least one of the following is true: (i) the skill agents information is a skill agents matrix A, (ii) the task allocation information is a task allocation matrix X, (iii) the bidding information is a bidding information matrix B, (iv) the price information is a price vector \vec{p} including a cost per skill of the skills that are required for the execution of the task, or (v) the timing information T is a timing matrix.

See—for example a scheduling data structures that includes <A^{j}, X^{j}, B^{j}, \vec{p}, T^{j}>.

According to an embodiment, the skill agent data structure 17 stores (a) task agents information 17-1 indicative of detected task agents, (b) reward information 17-2 that is indicative of the utility (to the skill agent) for performing tasks, (c) allocation information 17-3 indicative of portions of workloads (tasks) allocated to the skill agent by the task agents, (d) convergence information 17-4 indicative of convergence of scheduling processed involving the skill agent, (e) timing information 17-5 regarding earliest shared execution times—of sub-tasks shared between the skill agents and other shill agents, and (f) scheduling information 17-6 indicative of a current schedule of execution of sub-tasks by the skill agent.

According to an embodiment, each information item listed above (17-1 till 17-6) is stored in a different file of the skill agent data structure. According an embodiment, one or more items are stored in a single file of the skill agent data structure. According to an embodiment, an item is stored in more thana single file of the skill agent data structure. According to an embodiment, at least one of the following is true: (i) the task agents information is a task agents matrix V, (ii) the reward information is a reward matrix R, (iii) the allocation information is an allocation matrix X, (iv) the convergence information is a convergence vector \vec{ci}, or (v) the timing information T is a timing matrix.

See—for example a skill agent data structure referred also as a skill agent local view and includes <Vⁱ, Rⁱ, Xⁱ, \vec{ci}, T¹, σⁱ>.

According to an embodiment, the skill agent data structure is stored at a different memory unit and/or at a different memory bank that the task agent data structure. The same applied mutatis mutandis to different portions of the skill agent data structure and/or to different portions of the task agent data structure.

Both data structures and especially the messages exchanged between a task agent and a skill agent are very compact. For example—a message transmitted between the task agent and the skill agent may include tens till a few hundreds of bytes (for example between 10-100 bytes, between 20-200 bytes, between 30-300 bytes, between 40-400 bytes, between 50-500 bytes, and the like. Alternatively—a message may be longer than a few hundreds of bytes.

According to an embodiment, memory unit 10(1,3) includes a volatile memory and/or a non-volatile memory. The memory unit 10(1,3) may be a random access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of the computerized system. For example. and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory unit.

According to an embodiment, the at least one memory unit stores at least one database—such as any database known in the art—such as DB2®, Microsoft® Access, Microsoft® SQL Server, Oracle®, mySQL, PostgreSQL, and the like.

The communication unit may include a bus that represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

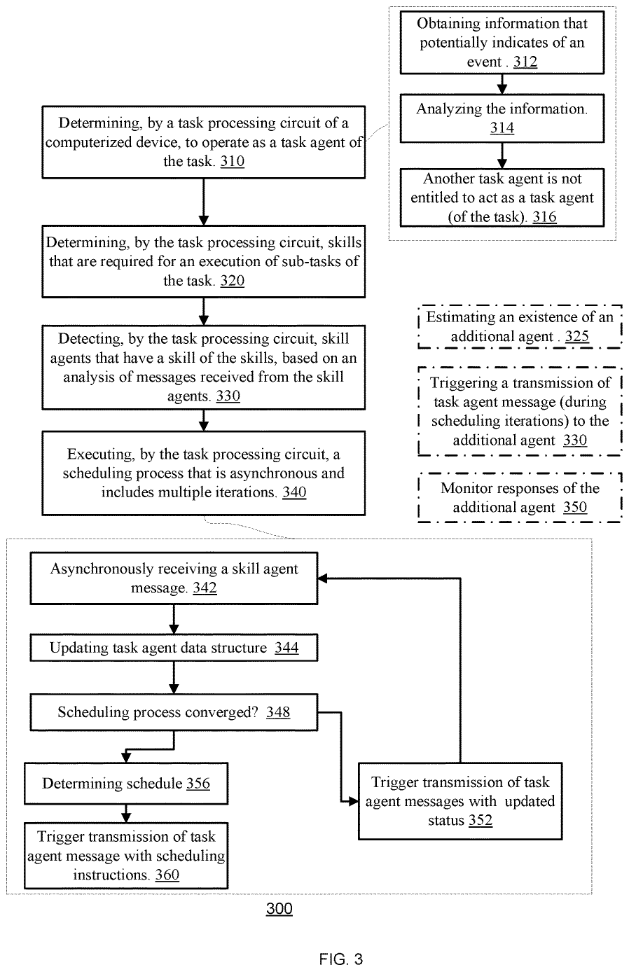

FIG. 3 illustrates an example of method 300 executable by a computerized system such as any of computerized systems 10(1)-10(Q).

According to an embodiment, method 300 is for dynamically scheduling a task using a scheduling process.

According to an embodiment, method 300 include step 310 of determining, by a task processing circuit of a computerized device, to operate as a task agent of the task.

According to an embodiment, step 310 includes:
Step 312 of obtaining information that potentially indicates of an event that triggers a task. The information may be information about an environment of the computerized device, an content of an intercepted communication, and the like. According to an embodiment, step 312 includes sensing, by a sensing unit of the computerized device, the information. Alternatively—step 312 includes receiving the information without sensing it.
Step 314 of analyzing, by the task processing circuit, the information to find an event that triggers an execution of the task. The task processing circuit may use a mapping between events and tasks. The mapping is generating in any manner
   it may be provided to the computerized system, determined by a user of the computerized system, determined by a manufactures of the computerized system, provided from another computerized device, provided from a remote server, and the like.
Step 316 of determining that another agent is not entitled to be the task agent. According to an embodiment, step 316 includes undergoing an arbitration process with the other agent when the other agent also requests to act as the task agent of the task. The agent and the other agent may obey to a defined arbitration rule—for example—the task agent is associated with an identifier that is lower (or higher) that the identifier of the other task agent. According to an embodiment, the defined arbitration rule is be responsive to load balancing considerations and/or to history of successful management of tasks, ad/or to priority, and the like. Using a defined rule saves communication iterations.

According to an embodiment, step 310 is followed by step 320 of determining, by the task processing circuit, skills that are required for an execution of sub-tasks of the task.

According to an embodiment, step 320 is followed by step 330 of detecting, by the task processing circuit, skill agents that have a skill of the skills, based on an analysis of messages received from the skill agents.

According to an embodiment, step 330 is followed by step 340 of executing, by the task processing circuit, a scheduling process that is asynchronous and includes multiple iterations.

According to an embodiment execution by the task processing circuit of each iteration of the multiple iteration includes:
Asynchronously receiving (342), by the task processing circuit, a skill agent message from any of the skill agents, the skill agent message includes (i) a bidding value related to a cost of using a skill of the skill agent during an execution of a sub-task, and (ii) timing information indicative of a suggested timing execution of the sub-task by the skill agent.
Updating (344), by the task processing circuit and based on a content of the skill agent message, a task agent data structure that is indicative of a state of the scheduling process, the task agent data structure is stored in a memory unit of the computerized device.
Analyzing (348) the scheduling data structure, by the task processing circuit, to determine whether the scheduling process has converged
According to an embodiment, when the scheduling process converged—step 348 is followed by step 356 of determining by the task processing circuit, a schedule of executing the task and step 360 of triggering by the task processing circuit, a transmission of scheduling instructions to the skill agents, by the task processing circuit.
According to an embodiment, when the scheduling process did not converged—step 348 is followed by step 352 of triggering by the task processing circuit a transmission of a task agent message to the relevant skill agents, the task agent message is indicative of an updated status of the scheduling process. Step 352 is followed by executing another iteration—for example jumping to step 342 for receiving another message.

According to an embodiment, an execution of each sub-task requires a usage of a single skill.

According to an embodiment, the task agent data structure stores (a) skill agents information indicative of the detected skill agents, (b) task allocation information indicative of an allocation of sub-tasks of the task to the skill agents, (c) bidding information indicative of bids from the skill agents related to execution of the sub-tasks of the tasks, (d) price information indicative of sums of prices per sub-task of the task, and (e) timing information regarding a suggested timing for starting at least one sub-task of the task.

According to an embodiment, at least one of the following is true: (i) the skill agents information is a skill agents matrix, (ii) the task allocation information is a task allocation matrix, (iii) the bidding information is a bidding information matrix, (iv) the price information is a price vector including a cost per skill of the skills that are required for the execution of the task, or (v) the timing information is a timing matrix.

According to an embodiment, step 324 includes updating the price information and the bidding information based on the message.

According to an embodiment, a set of sub-tasks of the task require using a certain skill, and the allocation of a sub-task of the set to a skill agent is indicative of a relative contribution of the skill agent to an execution of the set of the sub-tasks.

According to an embodiment, step 324 includes dividing a bidding value of a skill agent related to an execution of a sub-task of the set of sub-tasks, by a price of execution of the set of sub-tasks.

According to an embodiment, the task agent data structure stores timing relationship information regarding timing relationships between different sub-tasks.

According to an embodiment, an initial bidding value is determined based on a personal utility of the skill agent wherein the personal utility equals (a delayed start penalty of the skill agent for the skill)*(a utility contribution of the skill agent using the skill for executing the sub-task)−(an interruption penalty for the skill agent using the skill to work on the sub-task).

According to an embodiment, a non-initial bidding value is further responsive to a task allocation information.

According to an embodiment, method 300 further includes step 325 of estimating an existence of an additional agent that has a skill of the skill and did not communicate with the task agent following the determination by the task processing circuit, to act as the task agent. According to an embodiment, the estimate is based on operations executed by the additional agent in the past and/or communication conditions and/or a distance between the additional agent and the task agent, and the like.

According to an embodiment, step 330 includes triggering a transmission of the task agent message to the additional agent.

According to an embodiment, method 300 further includes step 350 monitoring a responses of the additional agent. Once the additional agent responds and can be used as a skill agent—it is regarded to be a skill agent.

Steps 325, 330 and 350 may be included in step 340.

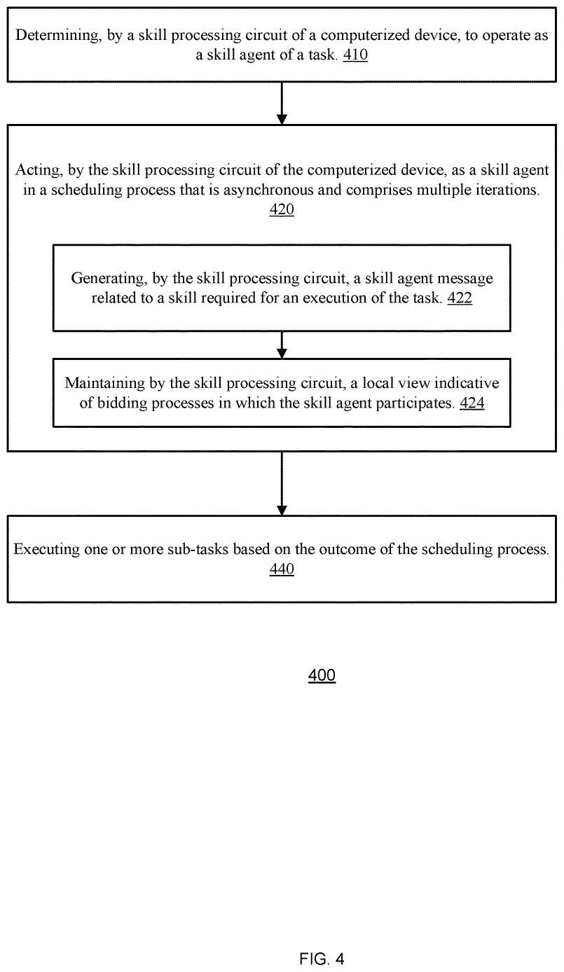

FIG. 4 illustrates an example of method 400 executable by a computerized system such as any of computerized systems 10(1)-10(Q). According to an embodiment, method 400 is for operating a skill agent.

According to an embodiment, method 400 includes step 410 of determining, by a skill processing circuit of the computerized device, to act as a skill agent. According to an embodiment the determining is triggered by receiving a message from a task agent that requires a usage of a skill exhibited by the skill agent. The determining may be based on one or more additional parameters such as previous commitments of the skill agent to participate in the execution of other tasks, available resources, state of one or more communication links (for example not acting as a skill agent when the quality of communication is below a defined communication quality).

According to an embodiment, step 410 is followed by step 420 of acting, by the skill processing circuit of the computerized device, as a skill agent in a scheduling process that is asynchronous and comprises multiple iterations.

According to an embodiment, step 420 includes participating in iterations of the scheduling process. The participating includes step 422 of generating, by the skill processing circuit, a skill agent message related to a skill required for an execution of the task, wherein the skill agent message includes a bidding value related to a cost of using the skill of the skill agent during an execution of a sub-task of the task, and timing information indicative of a suggested timing execution of the sub-task by the skill agent.

According to an embodiment, an initial value of the bidding value is determined based on a personal utility of the skill agent.

The personal utility equals (a delayed start penalty of the skill agent for the skill)*(a utility contribution of the skill agent using the skill for executing the sub-task)−(an interruption penalty for the skill agent using the skill to work on the sub-task).

According to an embodiment, step 420 includes step 424 of maintaining by the skill processing circuit, a local view indicative of scheduling processes in which the skill agent participates.

According to an embodiment, step 420 is followed by step 440 of executing one or more sub-tasks based on the outcome of the scheduling process.

According to an embodiment step 440 includes at least one of: autonomously controlling an execution of the other task, or autonomously controlling an autonomous movement of an vehicle, or autonomously controlling an autonomous movement of an object (the object is moved by a machine controlled by the skill agent), or autonomously monitoring an environment, or controlling a path finding operation for determining paths of progress of a vehicle. The vehicle may be an arial vehicle, a ground vehicle, or a sea vessel.

According to an embodiment, the computerized device is a part of a vehicle, or in communication with a vehicle.

According to an embodiment, any combination of one or more steps of method 300 and one or more steps of method 400 is provided.

According to an embodiment, various are made in regarding to tasks, skills and agents. There is a set of cooperative agents A={a₁, a₂, . . . , aₙ}, a set of tasks V={v₁, v₂, . . . , vₙ}, and a set of unique skills S={s₁, s₂, . . . , sₙ}.

Each agent aᵢ has a subset Sᵢ∈S of skills and each task vⱼ has a subset Sⱼ in S of required skills.

$${v}_{j}^{k}$$

is a sub-task of vⱼ for which there is a specified skill sₖ∈Sⱼ.

For each sub-task

$${v}_{j}^{k}$$

there is a required workload

$${w}_{j}^{k}$$

which specifies the workload of a specific skill sₖ that should be applied to sⱼ in the combined effort for completing this task.

Task vⱼ is completed only if for each of its sub-tasks, the proper amount of work has been performed by agents that possess the required skills.

Each task and each agent has a physical location. The set of all possible locations is denoted by L. The time it takes to travel between two locations is given by the function rho: L×L→[0, +∞).

An allocation of tasks to agents is denoted by a n×m×k matrix X where entry xᵢⱼₖ is the fraction of sub-task

$${v}_{j}^{k}$$

that is assigned to agent aᵢ.

According to an embodiment, an agent performs a single sub-task at a time and utilizes one skill at a time.

Let Mᵢ be the number of sub-tasks, agent aᵢ is allocated to. The schedule of aᵢ is denoted sigma i and it contains a sequence of Mᵢ triplets

$$Cap ( {v}_{j}^{k} , q ) .$$

specifying the skill that is being performed on a specific sub task, and the start and end time for applying that skill by the agent, respectively. Multiple agents can share a single sub-task. The amount of time an agent must spend on the task is equal to its allocated fraction of the workload

$$ft - st = {x}_{ijk} {w}_{j}^{k} .$$

The utility that agents derive from applying a skill to some task depends on the number of agents q∈N that handle it simultaneously. It is denoted by the non-negative capability function,

$$Cap ( {v}_{j}^{k} , q ) .$$

Let

$${d}_{q}^{{v}_{j}^{k}}$$

be the time that q agents are working together on

$${v}_{j}^{k}$$

in some solution (schedule), [symbol] for the problem.

Thus

$$q \frac{{d}_{q}^{{v}_{j}^{k}}}{{w}_{j}^{k}}$$

is the relative part of the mission that is performed by q agents simultaneously.

The initial utility

$${inu}_{j}^{k}$$

that can be derived by the agents for completing the performance of

$${v}_{j}^{k}$$

in [symbol] is:

$${inu}_{j}^{k} ( \text{?} ) = {\sum }_{q = 1}^{{n}_{j}^{k}} q \frac{{d}_{q}^{{v}_{j}^{k}}}{{w}_{j}^{k}} Cap ( {v}_{j}^{k} , q )$$

where

$${n}_{j}^{k}$$

is the limited amount of agents required for handling

$${v}_{j}^{k} .$$

The total initial utility for performing all skills of vⱼ in [symbol] is

$${inu}_{j} ( \text{?} ) = {\sum }_{{s}_{k} ∈ {s}_{j}} {inu}_{j}^{k} ( \text{?} )$$

The utility derived for completing the performance of task vⱼ depends also on the soft deadline function δ(vⱼ,t): V×[0,+∞)→(0,1], which is monotonically non-increasing in t. Thus, the discounted utility (duⱼ) for task

$${v}_{j}^{k} ,$$

Initially handled at time tᵥⱼ is: duⱼ( [symbol] )=δ(vⱼ, tᵥⱼ) inuⱼ( [symbol] ).

The dynamic problem is represented as a sequence of static problems, each instantiated when a new task arrives. In the dynamic problem, tasks arise over time. We denote the arrival time of a task vⱼ by α(vⱼ). Thus, the discounted utility is dependent on the task's arrival time: duⱼ( [symbol] )=δ(vⱼ, tᵥⱼ−α(vⱼ)) inuⱼ( [symbol] ).

The current task (if any) that is being performed by agent a i and the current skill that she is using, are denoted by ctᵢ and csᵢ, respectively. Agents can interrupt the performance of their current task. The penalty for task interruption,

$${π ( c {t}_{i} , {Δ}_{cti}^{csi} )}^{2}$$

depends on the interrupted task ctᵢ and the amount of workload left for skill csᵢ while abandoning,

$${Δ}_{c t i}^{c s i} .$$

The total utility derived for sⱼ is thus:

$${U}_{vj} ( \text{?} ) = {du}_{j} ( \text{?} ) - {\sum }_{ai : cti = vj / ∖ {v}_{S 1}^{t} differs cti} π ( cti , {Δ}_{cti}^{csi} )$$

Where

$${v}_{s 1}^{i}$$

the first task in agent's schedule. The total team utility for solution [symbol] is:

$$SW ( \text{?} ) = {\sum }_{vj ∈ V} {U}_{vj} ( \text{?} )$$

The suggested process takes into account communication disturbances, by using a Constrained Communication Graph (CCG), that represents the possibly dynamically changing uncertainty in the communication between agents.

To represent the communication limitations, in a CCG, every link of communication between agents (the vertexes) is represented by an edge and the constraint on each edge defines the latency and probability of a message loss. Formally, for every edge eᵢⱼ in the CCG, tdₑᵢⱼ is the function that represents the delay on eᵢⱼ (i.e., it calculates the time between when a message is sent and when it is received via edge eᵢⱼ. In addition, pl plₑᵢⱼ∈[0,1) is the probability that a message sent through the communication link represented by eᵢⱼ is lost.

### Fisher Market Clearing Task Allocation

A synchronous heterogeneous task allocation that can be implemented both in a centralized and distributed manner. The distributed implementation is by design synchronous. The algorithm is composed of two phases. The first generates the allocation and defines the cooperation among agents. The second determines the schedule according to which agents will perform the sub-tasks allocated to them.

The first phase manipulates a Fisher market clearing (FMC) algorithm in order to generate the allocation and ad-hoc coalitions that will perform tasks. This is done using a matrix a R that is a 3-dimensional (3D) matrix of size n×m×1 is generated. Each entry rᵢⱼₖ in R represents the personal utility that agent aᵢ will derive if it will perform sub-task

$${v}_{j}^{k} ,$$

assuming it will start moving towards it and perform the sub-task when it arrives. If agent aᵢ does not possess skill sₖ or task vⱼ does not require it, the value of entry rᵢⱼₖ will be zero. The utility is constructed ignoring the inter-task ordering constraints. It does take into consideration the maximum utility that agents can derive by performing the sub-task (according to the capability function), a penalty for late execution and for not completing the current task the agent is performing. Formally:

$${r}_{ijk} = δ ( {v}_{j} , ρ ( {a}_{i} , {v}_{j} ) ) C a p ( {v}_{j}^{k} , {n}_{j}^{k} ) - π ( c {t}_{i} , {Δ}_{c t i}^{c s i} )$$

where the penalty is omitted if

$$c {t}_{i} = {v}_{j}^{k} .$$

In relation to the Fisher market-clearing allocation. A skill agent i is denoted aaᵢ and a task agent representing task vⱼ is denoted taⱼ. Skill agents iteratively submit bids to the task agents regarding specific sub-tasks and are in turn awarded provisional allocations, which they use to modify their bids in the next round. Formally, the bid of aaᵢ on sub-task

$${v}_{j}^{k}$$

at time t is denoted by bᵢⱼₖ(t).

The allocation that is calculated by the task agent taⱼ is

$${x}_{ijk} = \frac{{b}_{ijk} ( t )}{{Σ}_{i} {b}_{ijk} ( t )}$$

and the next bid is

$${b}_{ijk} ( t + 1 ) = \frac{{u}_{ijk} ( t )}{{u}_{i} ( t )} {b}_{ijk} ( t )$$

where uᵢⱼₖ(t)=(xᵢⱼₖrᵢⱼₖ)^{ρ}^{ᵢ} and uᵢ(t)=u i(t)=ΣⱼΣₛ uᵢⱼₖ(t). The algorithm converges to a Fisher market equilibrium in pseudo-polynomial time.

In the second phase, the sub-tasks allocated to each of the skill agents are scheduled to reflect the spatial and temporal inter-task and inter-agent constraints. Each aaᵢ orders the sub-tasks allocated to it greedily prioritizing them according to the ratio between the utility derived from performing them and the required workload (i.e, Bang per Buck). Subsequently, the initial schedule for each skill agent is determined, i.e., the estimated arrival time for each sub-task

$${t}_{{v}_{j}^{k}}^{i} .$$

Then, aaᵢ sends

$${t}_{{v}_{j}^{k}}^{i}$$

to taⱼ (for all sub-tasks in σⁱ). The task agent taⱼ receives, updates and maintains the start times

$${t}_{{v}_{k}^{j}} .$$

### If

$${v}_{j}^{k}$$

is a shared sub-task, taⱼ then communicates

$${t}_{{v}_{k}^{j}}$$

to all skill agents that share

$${v}_{j}^{k} .$$

Upon receiving a

$${t}_{{v}_{k}^{j}}$$

message, aaᵢ checks if its individual schedule can be improved by advancing sub-tasks that are not shared, without delaying the execution of shared sub-tasks. The result of this phase is that each skill agent holds a schedule of the sub-tasks allocated to it, in the order that it will perform them.

The suggested process is designed to be (and evidently is) robust both to message latency and message loss.

The suggested process exhibits the following:
Agents do not wait for messages to arrive from all their neighbors in order for a computation step to begin. On the contrary, each message received triggers such a computation step. A neighbour of a task agent is a skill agent that participates in the scheduling process. A neighbour of a skill agent is a task agent of a scheduling process in which the skill agent participates.
two phases of synchronous allocation and synchronous scheduling are merged into a single step and performed simultaneously.
There is no central entity that is aware of the location and importance of all tasks present in the scenario and that it propagates this information to the agents. Rather—in the suggested solution, agents dynamically discover tasks and propagate the relevant information to their peers.

In the suggested solution the skill agents and task agents, operate in perform an asynchronous distributed environments. Throughout the execution, neighboring agents exchange messages. When an agent receives a message, it performs local computation and sends messages including the results of this calculation (i.e., agents send their bids and task agents send allocations). The computations include updating values—and are simple and may require a negligible amount of resources.

According to an embodiment, the role of a task agent is performed by a computerised devices that also acts as a skill agents, e.g., the task agent may be the first agent to identify the task. The communication graph is bipartite, i.e., the neighbors of each skill agent are only task agents and vice versa.

Every task agent taⱼ representing task, has a local view <A^{j}, X^{j}, B^{j}, \vec{p}, T^{j}> where A^{j} is a set of skill agents that can apply at least one skill as part of the performance of and derive positive utility (i.e., neighboring skill agents), X^{j} and B^{j} are matrices of allocations and bids of neighboring agents to the required skills of the task. \vec{p} is a vector of prices where T^{j} is the matrix of the earliest times that the agents in A^{j} are able to perform the sub-tasks. The price for each sub-task (associated with a single skill) is the sum of the latest bids for this task (skill) that arrived from each of the skill agent neighbors.

Each message sent from aaᵢ to the taⱼ includes

$$< {aa}_{i} , t {a}_{i} , {s}_{k} , b i {d}_{ik} , {t}_{{v}_{j}^{k}} > ,$$

where aaᵢ and taᵢ indicate the sender skill agent and the receiving task agent, bidᵢₖ is the bid of aaᵢ for utilizing skill sₖ and

$${t}_{{v}_{k}^{j}}$$

is the earliest time that aaᵢ can perform the sub-task.

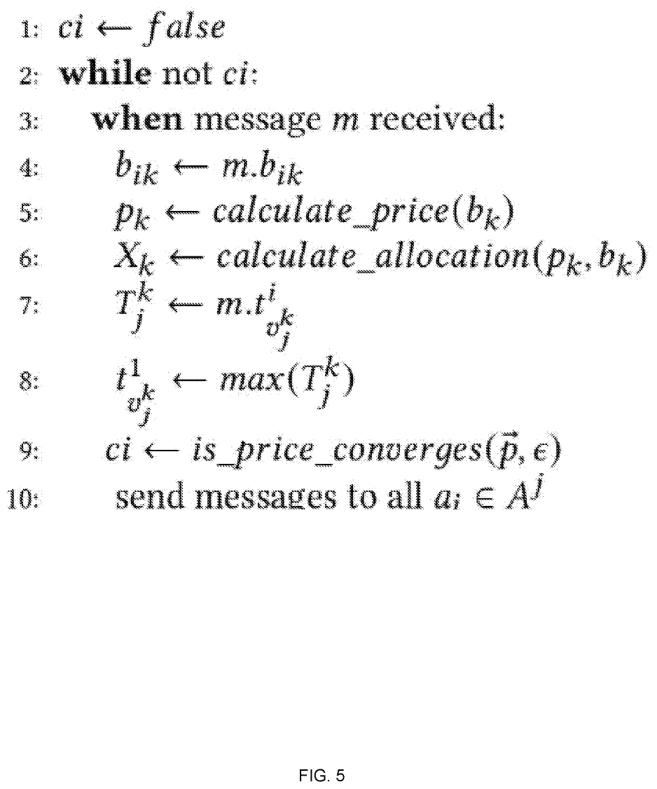

FIG. 5 illustrates an implementation of a method—and lists the actions of task agent taᵢ when handling incoming messages.

First, for each new message, matrix B^{j} is updated with the new bidᵢₖ (line 4).

Next, the prices for all skills are calculated by pₖ=Σ_{i∈A} bᵢₖ in \vec{p} (line 5). This provides the overall bids per skill.

New allocations in Xₖ are determined by

$${x}_{ik} = \frac{{b}_{ik}}{{p}_{k}} \times$$

(line 6). This provides a relative allocation of bits.

Lines 7 and 8 refer to the scheduling process, which is integrated into a single iterative computation. The time

$${t}_{{v}_{k}^{j}}$$

is updated in T^{j} and the earliest time that allocated agents to sub-task can perform concurrently,

$${t}_{{v}_{j}^{k}}^{1} ,$$

is updated with the max time in the row

$${T}_{j}^{k} .$$

The task agent's algorithm runs until the prices for all skills converge—when the cost calculated during the previous iterations differs by less than a defined amount (epsilon) from the cost calculated during the current iteration. The defined amount can be determined in any manner. For example—epsilon may equal 0.00005 or may differ from said value.

A convergence indicator ci is updated when reaching a convergence. (line 9).

Finally, messages are sent to each aaᵢ in A^{j} with the up-to-dated allocations xᵢₖ∈X, the earliest sharing time

$${t}_{{v}_{j}^{k}}^{1}$$

and the convergence indicator ci (line 10).

Every skill agent aaᵢ also has a local view <Vⁱ,Rⁱ,Xⁱ,\vec{ci},T¹,σⁱ>. Vⁱ is a set of neighboring task agents that aaᵢ is aware of. Rⁱ is the reward matrix in which every entry

$${r}_{{v}_{k}^{j}}$$

specifies the expected utility derived by aaᵢ for applying a skill sₖ for performing task vⱼ, and Xⁱ is the allocation matrix that specifies the portion of workload that aaᵢ is allocated for each such combination of skill and task. \vec{ci} indicates whether each neighboring task agent has converged where |\vec{ci}|=|Vⁱ|, and

$${t}_{{v}_{j}^{k}}^{1}$$

consists of the earliest shared execution times. σⁱ is the current schedule of agent aaᵢ.

According to an embodiment, there are two types of messages that skill agent aaᵢ can receive: a handshake message (HSM) and a standard message (SM).

According to an embodiment a single type of message is used.

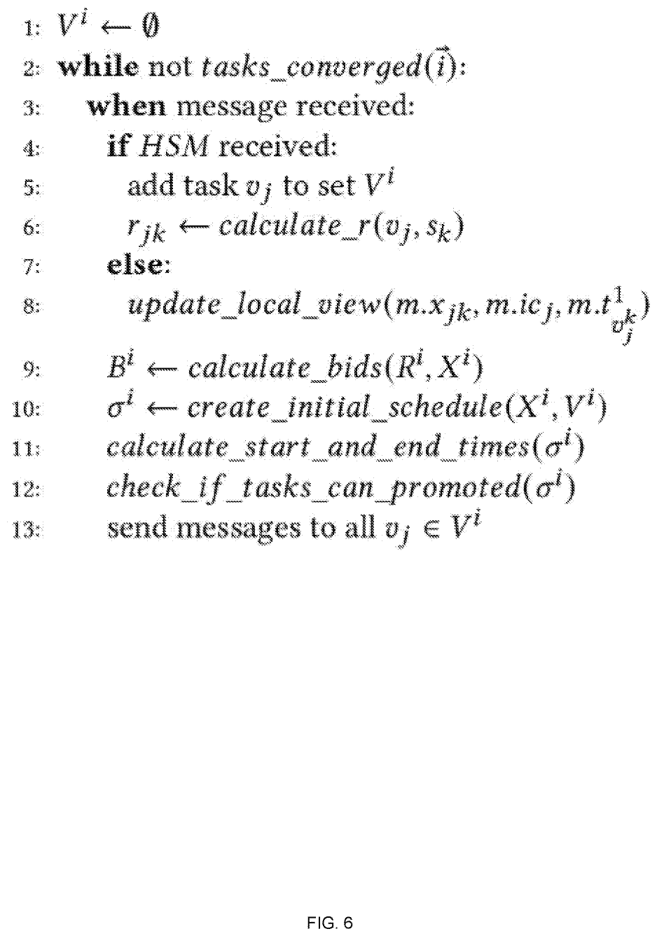

The handshake message contains initial information regarding new task vⱼ discovered by one of the agents. This type of message allows tasks to be asynchronously detected by the skill agents. The standard message includes the dynamic changing information throughout the execution of the embodiment of FIG. 6 (line 10).

The embodiment of FIG. 6 presents the skill agent aaᵢ actions when receiving messages. First, the agent distinguishes between the two types of messages, and reacts accordingly. If the message type is a HSM, the new task vⱼ is added to the set Vⁱ and the personal utility rⱼₖ is calculated for each of the skills that aaᵢ has and vⱼ requires (line 5-6).

If the message type is a standard message (i.e., the task already exists in Vⁱ): Xⁱ is updated with xᵢₖ, convergence vector indicator \vec{ci} is updated with cᵢⱼ, and the earlier shared execution time

$${t}_{{v}_{j}^{k}}^{1}$$

is updated in T¹ (line 8).

After updating its local view, the skill agent proceeds to re-calculate its bids as follows:

$${b}_{jk} = \frac{{r}_{jk} * {x}_{jk}}{{\sum }_{{j}^{′} , {k}^{′}} {r}_{{j}^{′} , {k}^{′}} * {x}_{{j}^{′} , {k}^{′}}} .$$

For new tasks, for which there is not yet an allocation in the agent's local view, we assume xⱼₖ=1 (line 9).

The following step include having the skill agent calculating its own schedule only for old tasks. The initial schedule is determined by sorting all allocations to tasks in Xⁱ (the tasks that were allocated to skill agent aaᵢ) according to their Bang per Buck i.e.,

$$\frac{{r}_{ijk} * {x}_{ijk}}{{\sum }_{{x}_{ijk} ∈ {x}_{i}} {r}_{ijk} * {x}_{ijk}}$$

(line 10).

According to initial schedule the skill agent's arrival time for each of the tasks allocated to it is calculated. The calculation of the arrival time to the first task considers only the travel time. The calculation of the arrival times to the rest of the tasks allocated to it takes into consideration in addition to the travel time, the time that the skill agent spend performing previous tasks (line 11). Then, for every sub-task

$${v}_{j}^{k}$$

in σⁱ she checks if the time

$${t}_{{v}_{j}^{k}}^{1}$$

in T¹ is larger than the time that was scheduled for the allocation, it tries to promote in the queue tasks where sharing is not required; and the final time

$${t}_{{v}_{j}^{k}}^{i}$$

of the arrival to task is determined (lines 12).

Finally, each aaᵢ sends messages to all neighboring task agents in Vⁱ, with the updated bids, bⱼₖ, and its arrival time

$${t}_{{v}_{j}^{k}}^{i} ,$$

as it appears in the up-to-date schedule σⁱ (line 13).

Referring the indices of various bids and other information unit sent during the process—assuming that task agent taⱼ and skill agent aaᵢ communicate in relation to task vⱼ—the task agent will use the index i while the skill agent will refer to index j—for example the skill agent will calculate a value bⱼₖ and the task agent will review the value as bᵢₖ.

The suggested process was tested by the inventors and the tests illustrate that the suggested process is robust and can properly operate even when these are major communication losses. The description of the experiments is found in U.S. provisional patent Ser. No. 63/436,892 filing date Jan. 4, 2023 which is incorporated herein by reference.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

This application provides a significant technical improvement over the prior art—especially an improvement in computer science.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type. Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method that is computer based and is for dynamically scheduling a task using a scheduling process, the method comprises:
determining, by a task processing circuit of a computerized device, to operate as a task agent of the task;
determining, by the task processing circuit, skills that are required for an execution of sub-tasks of the task;
detecting, by the task processing circuit, skill agents that have a skill of the skills, based on an analysis of messages received from the skill agents;
executing, by the task processing circuit, a scheduling process that is asynchronous and comprises multiple iterations, wherein an execution by the task processing circuit of each iteration of the multiple iteration comprises:
asynchronously receiving, by the task processing circuit, a skill agent message from any of the skill agents, the skill agent message comprises (i) a bidding value related to a cost of using a skill of the skill agent during an execution of a sub-task, and (ii) timing information indicative of a suggested timing execution of the sub-task by the skill agent;
updating, by the task processing circuit and based on a content of the skill agent message, a task agent data structure that is indicative of a state of the scheduling process, the task agent data structure is stored in a memory unit of the computerized device;
analyzing the scheduling data structure, by the task processing circuit, to determine whether the scheduling process has converged;
following a convergence of the scheduling process, determining by the task processing circuit, a schedule of executing the task and triggering by the task processing circuit, a transmission of scheduling instructions to the skill agents, by the task processing circuit and;
while the scheduling process is not converged, triggering by the task processing circuit a transmission of a task agent message to the relevant skill agents, the task agent message is indicative of an updated status of the scheduling process.

2. The method according to claim 1, wherein an execution of each sub-task requires a usage of a single skill.

3. The method according to claim 1, wherein the task agent data structure stores (a) skill agents information indicative of the detected skill agents, (b) task allocation information indicative of an allocation of sub-tasks of the task to the skill agents, (c) bidding information indicative of bids from the skill agents related to execution of the sub-tasks of the tasks, (d) price information indicative of sums of prices per sub-task of the task, and (e) timing information regarding a suggested timing for starting at least one sub-task of the task.

4. The method according to claim 3, at least one of the following is true: (i) the skill agents information is a skill agents matrix, (ii) the task allocation information is a task allocation matrix, (iii) the bidding information is a bidding information matrix, (iv) the price information is a price vector including a cost per skill of the skills that are required for the execution of the task, or (v) the timing information is a timing matrix.

5. The method according to claim 3, wherein the updating of the task agent data structure comprises updating the price information and the bidding information based on the message.

6. The method according to claim 3, wherein a set of sub-tasks of the task require using a certain skill, and wherein an allocation of a sub-task of the set to a skill agent is indicative of a relative contribution of the skill agent to an execution of the set of the sub-tasks.

7. The method according to claim 6, wherein the updating of the task agent data structure comprises dividing a bidding value of a skill agent related to an execution of a sub-task of the set of sub-tasks, by a price of execution of the set of sub-tasks.

8. The method according to claim 1, wherein the task agent data structure stores timing relationship information regarding timing relationships between different sub-tasks.

9. The method according to claim 1, wherein an initial bidding value is determined based on a personal utility of the skill agent wherein the personal utility equals (a delayed start penalty of the skill agent for the skill)*(a utility contribution of the skill agent using the skill for executing the sub-task)−(an interruption penalty for the skill agent using the skill to work on the sub-task).

10. The method according to claim 9, wherein a non-initial bidding value is further responsive to a task allocation information.

11. The method according to claim 1, wherein the determining to operate as a task agent of the task comprises:
sensing, by a sensing unit of the computerized device, information about an environment of the computerized device;
analyzing, by the task processing circuit, the sensed information to find an event that triggers an execution of the task; and
determining that another agent is not entitled to be the task agent.

12. The method according to claim 11, wherein the determining that the other agent is not entitled to be the task agent comprises undergoing an arbitration process with the other agent when the other agent also requests to act as the task agent of the task.

13. The method according to claim 1, further comprising:
estimating an existence of an additional agent that has a skill of the skill and did not communicate with the task agent following the determination by the task processing circuit, to act as the task agent;
triggering a transmission of the task agent message to the additional agent; and
monitoring a reception of a message by the additional agent.

14. The method according to claim 1, further comprising determining, by a skill processing circuit of the computerized device, to act as a skill agent.

15. The method according to claim 14, comprising acting, by the skill processing circuit of the computerized device, as a skill agent in another scheduling process that is managed by another task agent.

16. The method according to claim 15, wherein the acting as the skill agent comprises generating, by the skill processing circuit, another skill agent message related to a skill required for an execution of the other task, wherein the other skill agent message comprises another bidding value related to a cost of using the other skill of the skill agent during an execution of another sub-task of another task, and other timing information indicative of another suggested timing execution of the other sub-task by the skill agent.

17. The method according to claim 16, wherein an initial value of the other bidding value is determined based on another personal utility of the skill agent wherein the other personal utility equals (another delayed start penalty of the skill agent for the other skill)*(another utility contribution of the skill agent using the other skill for executing the other sub-task)−(other interruption penalty for the skill agent using the other skill to work on the other sub-task).

18. The method according to claim 14, comprising executing the other sub-task, wherein the executing of the other sub task comprises autonomously controlling an execution of the other task.

19. The method according to claim 14, comprising executing the other sub-task, wherein the executing of the other sub task comprises autonomously controlling an autonomous movement of a vehicle.

20. The method according to claim 14, comprising executing the other sub-task, wherein the executing of the other sub task comprises autonomously controlling an autonomous movement of an object.

21. The method according to claim 14, comprising executing the other sub-task, wherein the executing of the other sub task comprises autonomously monitoring an environment.

22. The method according to claim 14, comprising executing the other sub-task, wherein the executing of the other sub-task comprises controlling a path finding operation.

23. The method according to claim 14, comprising maintaining by the skill processing circuit, a skill agent data structure indicative of scheduling processes in which the skill agent participates.

24. The method according to claim 1, comprising transmitting, during each iteration, the task agent message.

25. A non-transitory computer readable medium for dynamically scheduling a task using a scheduling process, the non-transitory computer readable medium stores instructions for:
determining, by a task processing circuit of a computerized device, to operate as a task agent of the task;
determining, by the task processing circuit, skills that are required for an execution of sub-tasks of the task;
detecting, by the task processing circuit, skill agents that have a skill of the skills, based on an analysis of messages received from the skill agents;
executing, by the task processing circuit, a scheduling process that is asynchronous and comprises multiple iterations, wherein an execution by the task processing circuit of each iteration of the multiple iteration comprises:
asynchronously receiving, by the task processing circuit, a skill agent message from any of the skill agents, the skill agent message comprises (i) a bidding value related to a cost of using a skill of the skill agent during an execution of a sub-task, and (ii) timing information indicative of a suggested timing execution of the sub-task by the skill agent;
updating, by the task processing circuit and based on a content of the skill agent message, a task agent data structure that is indicative of a state of the scheduling process, the task agent data structure is stored in a memory unit of the computerized device;
analyzing the scheduling data structure, by the task processing circuit, to determine whether the scheduling process has converged;
following a convergence of the scheduling process, determining by the task processing circuit, a schedule of executing the task and triggering by the task processing circuit, a transmission of scheduling instructions to the skill agents, by the task processing circuit and;
while the scheduling process is not converged, triggering by the task processing circuit a transmission of a task agent message to the relevant skill agents, the task agent message is indicative of an updated status of the scheduling process.

26. The non-transitory computer readable medium according to claim 25, wherein an execution of each sub-task requires a usage of a single skill.

27. The non-transitory computer readable medium according to claim 25, wherein the task agent data structure stores (a) skill agents information indicative of the detected skill agents, (b) task allocation information indicative of an allocation of sub-tasks of the task to the skill agents, (c) bidding information indicative of bids from the skill agents related to execution of the sub-tasks of the tasks, (d) price information indicative of sums of prices per sub-task of the task, and (e) timing information regarding a suggested timing for starting at least one sub-task of the task.

28. The non-transitory computer readable medium according to claim 27, at least one of the following is true: (i) the skill agents information is a skill agents matrix, (ii) the task allocation information is a task allocation matrix, (iii) the bidding information is a bidding information matrix, (iv) the price information is a price vector including a cost per skill of the skills that are required for the execution of the task, or (v) the timing information is a timing matrix.

29. The non-transitory computer readable medium according to claim 27, wherein the updating of the task agent data structure comprises updating the price information and the bidding information based on the message.

30. The non-transitory computer readable medium according to claim 27, wherein a set of sub-tasks of the task require using a certain skill, and wherein an allocation of a sub-task of the set to a skill agent is indicative of a relative contribution of the skill agent to an execution of the set of the sub-tasks.

31. The non-transitory computer readable medium according to claim 30, wherein the updating of the task agent data structure comprises dividing a bidding value of a skill agent related to an execution of a sub-task of the set of sub-tasks, by a price of execution of the set of sub-tasks.

32. The non-transitory computer readable medium according to claim 25, wherein the task agent data structure stores timing relationship information regarding timing relationships between different sub-tasks.

33. The non-transitory computer readable medium according to claim 25, wherein an initial bidding value is determined based on a personal utility of the skill agent wherein the personal utility equals (a delayed start penalty of the skill agent for the skill)*(a utility contribution of the skill agent using the skill for executing the sub-task)−(an interruption penalty for the skill agent using the skill to work on the sub-task).

34. The non-transitory computer readable medium according to claim 33, wherein a non-initial bidding value is further responsive to a task allocation information.

35. The non-transitory computer readable medium according to claim 25, wherein the determining to operate as a task agent of the task comprises:
sensing, by a sensing unit of the computerized device, information about an environment of the computerized device;
analyzing, by the task processing circuit, the sensed information to find an event that triggers an execution of the task; and
determining that another agent is not entitled to be the task agent.

36. The non-transitory computer readable medium according to claim 35, wherein the determining that the other agent is not entitled to be the task agent comprises undergoing an arbitration process with the other agent when the other agent also requests to act as the task agent of the task.

37. The non-transitory computer readable medium according to claim 25, that stores instructions for:
estimating an existence of an additional agent that has a skill of the skill and did not communicate with the task agent following the determination by the task processing circuit, to act as the task agent;
triggering a transmission of the task agent message to the additional agent; and
monitoring a reception of a message by the additional agent.

38. The non-transitory computer readable medium according to claim 25, that stores instructions for determining, by a skill processing circuit of the computerized device, to act as a skill agent.

39. The non-transitory computer readable medium according to claim 38, that stores instructions for acting, by the skill processing circuit of the computerized device, as a skill agent in another scheduling process that is managed by another task agent.

40. The non-transitory computer readable medium according to claim 39, wherein the acting as the skill agent comprises generating, by the skill processing circuit, another skill agent message related to a skill required for an execution of the other task, wherein the other skill agent message comprises another bidding value related to a cost of using the other skill of the skill agent during an execution of another sub-task of another task, and other timing information indicative of another suggested timing execution of the other sub-task by the skill agent.

41. The non-transitory computer readable medium according to claim 40, wherein an initial value of the other bidding value is determined based on another personal utility of the skill agent wherein the other personal utility equals (another delayed start penalty of the skill agent for the other skill)*(another utility contribution of the skill agent using the other skill for executing the other sub-task)−(other interruption penalty for the skill agent using the other skill to work on the other sub-task).

42. The non-transitory computer readable medium according to claim 38, that stores instructions for executing the other sub-task, wherein the executing of the other sub task comprises autonomously controlling an execution of the other task.

43. The non-transitory computer readable medium according to claim 38, that stores instructions for executing the other sub-task, wherein the executing of the other sub task comprises autonomously controlling an autonomous movement of a vehicle.

44. The non-transitory computer readable medium according to claim 38, that stores instructions for executing the other sub-task, wherein the executing of the other sub task comprises autonomously controlling an autonomous movement of an object.

45. The non-transitory computer readable medium according to claim 38, that stores instructions for executing the other sub-task, wherein the executing of the other sub task comprises autonomously monitoring an environment.

46. The non-transitory computer readable medium according to claim 38, that stores instructions for executing the other sub-task, wherein the executing of the other sub-task comprises controlling a path finding operation.

47. The non-transitory computer readable medium according to claim 38, that stores instructions for maintaining by the skill processing circuit, a skill agent data structure indicative of scheduling processes in which the skill agent participates.

48. The non-transitory computer readable medium according to claim 25, that stores instructions for transmitting, during each iteration, the task agent message.

49. A computerized device for dynamically scheduling a task using a scheduling process, the computerized device comprises:
a memory unit; and
a task processing circuit that is configured to:
determine to operate as a task agent of the task;
determine skills that are required for an execution of sub-tasks of the task;
detect skill agents that have a skill of the skills, based on an analysis of messages received from the skill agents;
execute a scheduling process that is asynchronous and comprises multiple iterations, wherein an execution by the task processing circuit of each iteration of the multiple iteration comprises:
asynchronously receiving, by the task processing circuit, a skill agent message from any of the skill agents, the skill agent message comprises (i) a bidding value related to a cost of using a skill of the skill agent during an execution of a sub-task, and (ii) timing information indicative of a suggested timing execution of the sub-task by the skill agent;
updating, by the task processing circuit and based on a content of the skill agent message, a task agent data structure that is indicative of a state of the scheduling process, the task agent data structure is stored in the memory unit;
analyzing the scheduling data structure, by the task processing circuit, to determine whether the scheduling process has converged;
following a convergence of the scheduling process, determining by the task processing circuit, a schedule of executing the task and triggering by the task processing circuit, a transmission of scheduling instructions to the skill agents, by the task processing circuit and;
while the scheduling process is not converged, triggering by the task processing circuit a transmission of a task agent message to the relevant skill agents, the task agent message is indicative of an updated status of the scheduling process.
